(19) United States
(12) Patent Application Publication
(10) Pub. No.: US 2015/0181257 A1
(43) Pub. Date: Jun. 25, 2015

(54) METHODS AND SYSTEMS FOR AN ADAPTER DEVICE BETWEEN VEHICLE INFOTAINMENT SYSTEMS AND ELECTRONIC DEVICES

(71) Applicant: GM GLOBAL TECHNOLOGY OPERATIONS LLC, Detroit, MI (US)

(72) Inventors: FAN BAI, ANN ARBOR, MI (US); DONALD K. GRIMM, UTICA, MI (US); TIMOTHY J. TALTY, BEVERLY HILLS, MI (US); MASSIMO OSELLA, TROY, MI (US); DAN SHAN, WARREN, MI (US)

(21) Appl. No.: 14/492,776

(22) Filed: Sep. 22, 2014

Related U.S. Application Data
(60) Provisional application No. 61/919,179, filed on Dec. 20, 2013.

(51) Int. Cl. H04N 21/218; H04N 21/41; H04N 21/61

(52) U.S. Cl. CPC H04N 21/218; H04N 21/6156; H04N 21/4104; H04N 21/4122; H04N 21/4126

(57) ABSTRACT

Systems for communicating between a display unit of a vehicle and a wireless electronic device are provided. In one embodiment, a system includes a first communication module that receives at least one of video data and audio data from the wireless electronic device according to a wireless communication protocol. A first converter module converts the at least one of video data and audio data from a data format generated by the wireless electronic device to a data format that is recognizable by the display unit of the vehicle. A second communication module communicates the converted at least one of video data and audio data to the display unit according to a wired communication protocol.

### CROSS-REFERENCE TO RELATED APPLICATIONS

This application claims priority to U.S. Provisional Patent Application No. 61/919,179, filed Dec. 20, 2013.

### TECHNICAL FIELD

The technical field generally relates to display devices of a vehicle, and more particularly relates to methods and systems for enabling projection of content from an electronic device on a display of a vehicle.

### BACKGROUND

Many consumers today regularly use portable consumer electronics devices, such as smartphones or tablets. When a user is in a vehicle, the electronic device may be stored in a purse or other location that is not readily accessible by the user.

Vehicles today regularly include an infotainment system that delivers information and entertainment to the user, which are sometimes referred to collectively as infotainment information. Infotainment information can be delivered in any of a wide variety of forms, including text, video, audio, and combinations of these. When the user is in the vehicle and the electronic device is stored away, it would be desirable to allow the video and other content of the electronic device to be delivered by the infotainment system. However, in some cases, the infotainment system is unable to communicate with the electronic devices due to a difference in the communication protocols used by both the infotainment system and the electronic devices. In addition, in some cases, the data format of a display unit or other unit of the infotainment system is different than the data formats of the electronic devices. Moreover, the display might require some different hardware capability to process video, audio, and control data obtained from the electronic devices.

Accordingly, it is desirable to provide methods and systems for facilitating the communication of data between the infotainment system of the vehicle and the electronic device. Furthermore, other desirable features and characteristics of the present invention will become apparent from the subsequent detailed description and the appended claims, taken in conjunction with the accompanying drawings and the foregoing technical field and background.

### SUMMARY

Systems for communicating between a display unit of a vehicle and a wireless electronic device are provided. In one embodiment, a system includes a first communication module that receives at least one of video data and audio data from the wireless electronic device according to a wireless communication protocol. A first converter module converts the at least one of video data and audio data from a data format generated by the wireless electronic device to a data format that is recognizable by the display unit of the vehicle. A second communication module communicates the converted at least one of video data and audio data to the display unit according to a wired communication protocol.

In another embodiment, a vehicle is provided. The vehicle includes a display unit, and an adapter device. The adapter device receives at least one of video data and audio data from a wireless electronic device according to a wireless communication protocol, converts the at least one of video data and audio data from a data format generated by the wireless electronic device to a data format that is recognizable by the display unit of the vehicle, and communicates the converted at least one of video data and audio data to the display unit according to a wired communication protocol.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes an infotainment system and a method to interact with an electronic device including a projection system in accordance with various embodiments; and

FIGS. 2-3 are functional block diagrams illustrating an infotainment system and a method to interact with an electronic device including the projection system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features.

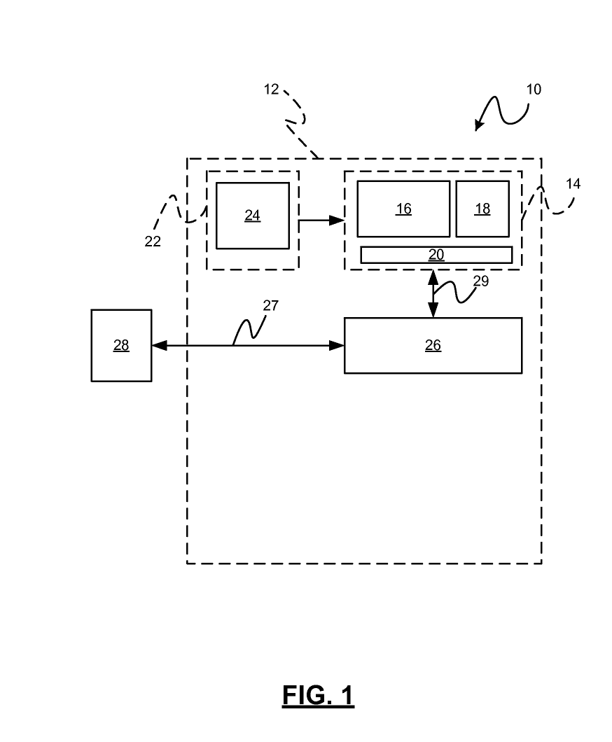

Referring now to FIG. 1, a projection system 10 for a vehicle 12 is shown in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale. AS can be appreciated, the components identified may be functional elements and may not necessarily be the physical partitioning of an actual projection system 10.

The vehicle 12 may be an automobile, an aircraft, a spacecraft, a watercraft, a sport utility vehicle, or any other type of vehicle and more generally the vehicle 12 may be any device or collection of devices that include video, audio and other data processing capabilities. In various embodiments, the vehicle 12 includes a infotainment system 14. In general, the infotainment system 14 includes a display 16, one or more audio devices 18 that could include both input and output audio devices, and one or more input/output control devices 20. The display 16 is configured to display content in the vehicle 12. The one or more audio devices 18 are configured to render or receive audio content in the vehicle 12. The one or more control devices 20 are configured to generate control signals based on a user's interaction with the control device 20. As can be appreciated, the one or more control devices 20 may be integrated with the display 16 (e.g., touch screen sensors) and/or may be separate from the display 16 (e.g., buttons, knobs, or switches that are separate from, the display 16).

The vehicle 12 further includes other vehicle components 22 that include control devices 24 that generate control signals based on a user's interaction with the control devices 24. The control signals are sent to the infotainment system 14 for controlling features of the infotainment system 14. For example, the vehicle component 22 may be a steering system (not shown) that includes control buttons, knobs, or switches on a steering wheel (not shown) of the steering system. The steering system generates control signals based on a driver's interaction with the control buttons, knobs, or switches to control features of the infotainment system 14. As can be appreciated, the vehicle components 22 and control devices 24 can be any components of the vehicle 12 having a control device 24, and is not limited to the present example. In various embodiments, the vehicle components 22 and the control device 24 may not directly require user input for the generation of control signals to the vehicle infotainment unit 14. For example, the component 22 may generate control signals based on various conditions of the vehicle 12 such as, for example, a vehicle transmission state, a vehicle speed, and a vehicle ignition state.

As shown, the projection system 10 includes an adapter device 26 that is configured to communicate data between the infotainment system 14 of the vehicle 12 and an electronic device 28. In general, the adapter device 26 enables video data, audio data, and/or other data such as sensor and user input data of the electronic device 28 to be sent to the infotainment system 14 to enable remote display, remote audio, remote use of sensor or user input data of the electronic device 28, in which the framebuffer of the electronic device 28 is captured as a video source, and the audio output of the electronic device 28 is captured as an audio source. This way, by using the adapter device 26, the infotainment unit 14 can fully replicate the screen output and the audio output of the electronic device 28, while users can use control provided by the infotainment unit 14 to control the electronic device 28. The adapter device 26 further enables control signals of the infotainment system 14 to be sent to the electronic device 28 to control features of the electronic device 28 thereby enabling remote control of the electronic device 28.

The electronic device 28 may be a smartphone, a tablet, a Bluetooth enabled gadget, or any other electronic device that is capable of communicating video data and/or audio data In addition, vehicle components 22 and control device 24 may not directly require user input for the generation of control signals to the vehicle infotainment unit 14. For example, component 22 may generate control signals based on various conditions of the vehicle such as vehicle transmission state, vehicle speed and vehicle ignition states as examples. For exemplary purposes the disclosure will be discussed in the context of the electronic device 28 being a smartphone that communicates video data and/or audio data In addition, vehicle components 22 and control device 24 may not directly require user input for the generation of control signals to the vehicle infotainment unit 14. For example, component 22 may generate control signals based on various conditions of the vehicle such as vehicle transmission state, vehicle speed and vehicle ignition states as examples. The electronic device 28 communicates with the adapter device 26 according to a communication protocol. The communication protocol can be based on a communication link 27 that is used to communicate the data. (e.g., BLE, Wi-Fi, Bluetooth, NFC, ANT, Zigbee, RFID, ultra wide band (low power Wi-Fi), all other variations of Wi-Fi, USB, etc.).

The adapter device 26 communicates with the infotainment system 14 according to a communication protocol. The communication protocol can be based on a communication link 29 that is used to communicate the data. In various embodiments, the communication link 29 may be a direct link of the display 16 (e.g., a communication link built in to the display 16). In various embodiments, the communication link 29 may be an indirect link to the display 16 (e.g., a CAN communication bus, or other communication bus of the vehicle 12 that links to the display 16). In still other embodiments, the communication link 29 may be an interface device (e.g., a USB or other device) that links the display 16 to the adapter device 26.

Since the communication protocol of the electronic device 28 is different than the communication protocol of the display 16 and the infotainment system 14, the adapter device 26 translates communications from the electronic device 28 to communications that are recognizable by the display 16 and the infotainment unit 14 and translates communications from the display 16 and the infotainment system 14 to communications that are recognizable by the electronic device 28. Likewise, since the format of the video data, the audio data, and/or the sensor and user input data of the electronic device 28 is different than the format of the video data, the audio data, and/or the sensor and user input data recognized by the display 16 and the infotainment system 14, the adapter device 26 converts the format of the data from the electronic device 28 to the format of the display 16 and the infotainment system 14. Since the format of the control data of the infotainment system 14 is different than the format of the control data recognized by the electronic device 28, the adapter device 26 translates the format of the data from the infotainment unit 14 to the format of the electronic device 28.

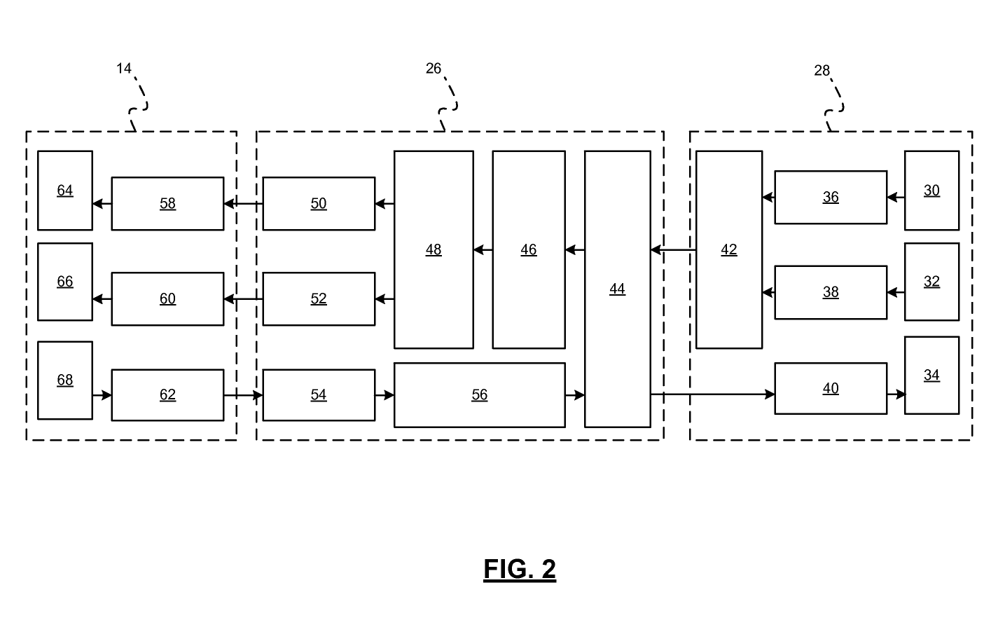

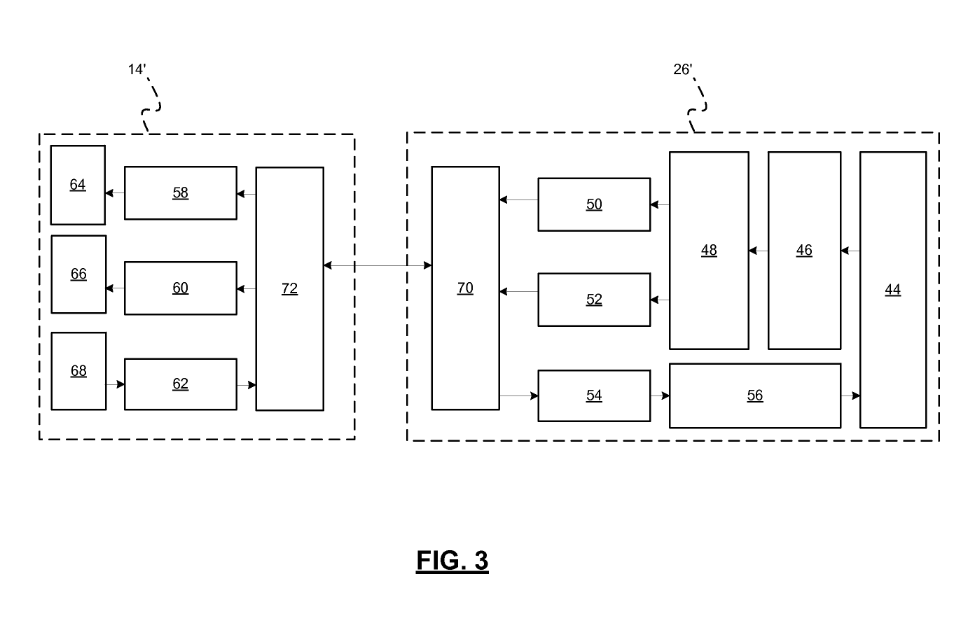

With reference now to FIGS. 2-3 and with continued reference to FIG. 1, functional block diagrams further illustrate the electronic device 28, the adapter device 26, and the infotainment system 14 in accordance with various embodiments. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. In addition, module is used to representation functional aspects the system. Actual hardware and/or software implementations to enable the functional aspects of the system may or may not be partitioned as shown in FIGS. 1-3. The electronic device 28, the adapter device 26, and the infotainment system 14 are shown to each include various modules. As can be appreciated, the modules shown for each of the electronic device 28, the adapter device 26, and the infotainment system 14 may be combined or further partitioned in various embodiments.

As shown in the embodiments of FIG. 2, the electronic device 28 includes a display module 30, an audio module 32, a control module 34, a video communication module 36, an audio communication module 38, a control communication module 40, and an encoder module 42. The display module 30 and the audio module 32 control the display of the video data and the playing of the audio data on the electronic device 28, respectively. The display module 30 provides the video data to be communicated to the adapter device 26 based on what is being displayed on the electronic device 28. The audio module 32 generates the audio data to be communicated to the adapter device 26 based on what is being played on the electronic device 28.

The video communication module 36 receives the video data and formats the video data for communication to the adapter device 26. The video communication module formats the communication according to the communication protocol used by the electronic device 28. The video communication communicates the video communications to the encoder module 42.

Likewise, the audio communication module receives the audio data and formats the audio data for communication to the adapter device 26. The audio communication module formats the communication according to the protocol used by the electronic device 28. The audio communication module communicates the audio communications to the encoder module 42.

Before sending the video communications and the audio communications, the encoder module 42 encodes the video communications and the audio communications and may use a compression method (e.g., H.264 or other method). Such compression methods allow the video data and the audio data to be streamed to the adapter device 26.

The control communication module 40 receives control communications from the adapter device 26 and processes the control communications to determine control data. The control communication from adapter device 26 may or may not be processed via the encoder module 42. The control communication module 40 provides the control data to the control module 34. The control methods include a rich variety of options, ranging from the user inputs on the touch screen to the user input on the steering wheel button to the user's audio command to even vehicle-generated sensor input/command. The control module 34 receives the control data and performs some control function on the electronic device 28 based on the control data. In various embodiments, the control function is based on the information displayed on the electronic device 28. In addition, the control module 34 is capable of communicating electronic device 28 sensor and user input data via the control communication module 40.

As further shown in FIG. 2, the adapter device 26 includes a communication module 44, a decoder module 46, a video/audio converter module 48, a video communication module 50, an audio communication module 52, a control communication module 54, and a control converter module 56. The communication module 44 transmits and receives data to and from the electronic device 28 according to the communication protocol of the electronic device 28. For example, the wireless module 44 receives the streamed video and audio communications from the electronic device 28 and transmits the control communications to the electronic device 28.

The decoder module 46 receives the video and audio communications from the communication module 44, and decodes the video and audio communications based on a decompression method (e.g., H.264 or other method). The decoder module 46 provides the decoded video and audio data to the audio/video converter module 48.

The audio/video converter module 48 receives the decoded video and audio data from the decoder module 46. The audio/video converter module 48 converts the decoded video data and the decoded audio data from a format generated by the electronic device 28 to a format that is recognized by the infotainment system 14 of the vehicle 12.

The video communication module 50 receives the formatted video data from the converter module 48 and formats video communications that include the formatted video data. For example, the video communications are formatted according to a communication protocol of the vehicle 12 (e.g., defined by the communication links 29 of the vehicle 12 that are being used to communicate the data) or a communication protocol of the infotainment system 14 (e.g., defined by communication links 29 of the infotainment system 14 that are being used to communicate the data). The video communication module 50 communicates the video communications to the infotainment system 14 based on the communication protocol of the vehicle 12 or the communication protocol of the infotainment system 14.

The audio communication module 52 receives the formatted audio data from the converter module 48 and formats audio communications that include the formatted audio data. For example, the audio communications are formatted according to a communication protocol of the vehicle 12 (e.g., defined by communication links 29 of the vehicle 12 that are being used to communicate the data) or a communication protocol of the infotainment system 14 (e.g., defined by communication links 29 of the infotainment system 14 that are being used to communicate the data). The audio communication module 52 communicates the audio communications to the infotainment system 14 based on the communication protocol of the vehicle 12 or the communication protocol of the infotainment system 14. The audio data may also be generated at the vehicle 12 and communicated back to electronic device 28.

The control communication module 54 receives control communications from the infotainment system 14, and processes the control communications in order to determine control data (e.g., data generated from a user's interaction with a control device 20 or 24). The control communication module 54 receives and processes the control communications based on a communication protocol of the vehicle 12 (e.g., defined by communication links of the vehicle 12 that are being used to communicate the data) or a communication protocol of the infotainment system 14 (e.g., defined by communication links of the infotainment system 14 that are being used to communicate the data). The control communication module 54 provides the control data to the control converter module 56.

The control converter module 56 receives the control data from the control communication module 54. The control converter module 56 converts the control data from a format generated by the infotainment system 14 of the vehicle 12 to a format that is recognized by the electronic device 28. In addition, sensor and user input data from the electronic device 28 can be communicated to the vehicle 12 and the infotainment system 14 using the communication module 40, the communication module 44, the control converter module 56, and the control communication module 54

The infotainment system 14 includes a video communication module 58, an audio communication module 60, a control communication module 62, a display module 64, an audio module 66, and a control module 68. The video communication module 58 receives the video communications from the adapter device 26, and processes the video communications to determine video data. The video communication module 58 receives and the processes the audio communications based on the communication protocol of the infotainment system 14 or the vehicle 12. The video communication module 58 provides the video data to the display module 64.

The audio communication module 60 receives the audio communications from the adapter device 26, and processes the audio communication to determine audio data. The audio communication module receives and processes the audio communications based on the communication protocol of the vehicle 12 or the infotainment system 14. The audio communication module 60 provides the audio data to the audio module 66.

The display module 64 and the audio module 66 control the display and the audio on the infotainment system 14. The display module 64 receives the video data and displays the video data on the display 16 of the infotainment system 14. The audio module 66 receives the audio data and plays the audio data through the audio device 18 of the infotainment system 14.

The control module 68 generates control data based on a user's interaction with a control device 20 or 24. In various embodiments, the control data includes instructions for controlling a feature associated with video that is displayed or the audio that is played. The control module 68 provides the control data to the control communications module 62. In addition, the vehicle component 22 may generate data regarding vehicle status such as transmission state, vehicle speed, and ignition state that will be communicated to the electronic device 28.

The control communication module 62 receives the control data from the control module 68, and formats control communications that include the control data. The control communication module 62 formats the communication based on a communication protocol of the infotainment system 14 or of the vehicle 12. The control communication module 62 communicates the control communication to the adapter device 26 based on the communication protocol of the infotainment system 14 or of the vehicle 12.

With reference now to FIG. 3, in various embodiments, the adapter device 26′ can include an interface module 70 that communicates with an interface module 72 of the display unit based on a communication protocol of the interface device of the infotainment system 14′ (e.g., a USB or other device). In various embodiments, all other the modules shown in FIG. 3 function similarly as discussed with regard to FIG. 2.

As shown in FIG. 3, the interface module 70 receives the video communications and the audio communications from the video communication module 50 and the audio communication module 52 respectively, and combines the video communications and the audio communications according to the communication protocol. The interface module 70 communicates the combined communications to the interface module 72 of the infotainment system 14′ based on the communication protocol.

In addition, the interface module 70 receives control communications from the interface module 72 of the infotainment system 14′ and processes the control communications. The interface module 70 provides the control communications to the control communication module 54. The control communication module 54 further processes the control communication similarly as discussed above.

The interface module 72 of the infotainment system 14′ receives the combined communications from the interface module 70 of the adapter device 26 and processes the combined communications to determine the video communications and the audio communications. The interface module 72 provides the video communications and the audio communications to the video communication module 58 and the audio communication module 60, respectively. The video communication module 58 and the audio communication module 60 process the communications similarly as discussed above.

In addition, the interface module 72 of the infotainment system 14′ receives control communications from the control communication module 62, and formats the control communications according to the communication protocol. The interface module 72 communicates the control communications to the interface module 70 of the adapter device 26.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A system for communicating between a display unit of a vehicle and a wireless electronic device, comprising:
a first communication module that receives at least one of video data and audio data from the wireless electronic device according to a wireless communication protocol;
a first converter module that converts the at least one of video data and audio data from a data format generated by the wireless electronic device to a data format that is recognizable by the display unit of the vehicle; and
a second communication module that communicates the converted at least one of video data and audio data to the display unit according to a wired communication protocol.

2. The system of claim 1, further comprising a decoder module that decodes the at least one of video data and audio data from the wireless electronic device based on a decompression method.

3. The system of claim 1, further comprising:
a third communication module that receives control data from the display unit of the vehicle according to a wired communication protocol; and
a second converter module that converts the control data from a format generated by the display unit to a format that is recognizable by the wireless electronic device.

4. The system of claim 3, wherein the first module communicates the converted control data to the wireless electronic device based on the wireless communication protocol.

5. The system of claim 1, wherein the first communication module receives the video data and the audio data from the wireless electronic device, and wherein the first converter module converts the video data and the audio data from the data format generated by the wireless electronic device to the data format that is recognizable by the display unit of the vehicle.

6. The system of claim 5, wherein the second communication module communicates the converted video data and audio data to the display unit according to the wired communication protocol.

7. The system of claim 5, further comprising a third communication module, wherein the second communication module communicates the converted video data to the display unit according to the wired communication protocol, and wherein the third communication module communicates the converted audio data to the display unit according to the wired communication protocol.

8. The system of claim 1, wherein the wired communication protocol is based on a direct communication link to the display unit.

9. The system of claim 1, wherein the wired communication protocol is based on an indirect communication link to the display unit through the vehicle.

10. A vehicle, comprising:
a display unit; and
an adapter device that receives at least one of video data and audio data from a wireless electronic device according to a wireless communication protocol, that converts the at least one of video data and audio data from a data format generated by the wireless electronic device to a data format that is recognizable by the display unit of the vehicle, and that communicates the converted at least one of video data and audio data to the display unit according to a wired communication protocol.

11. The vehicle of claim 10, wherein the adapter device decodes the at least one of video data and audio data from the wireless electronic device based on a decompression method.

12. The vehicle of claim 10, wherein the adapter device receives control data from the display unit of the vehicle according to a wired communication protocol, and converts the control data from a format generated by the display unit to a format that is recognizable by the wireless electronic device.

13. The vehicle of claim 12, wherein the wherein the adapter device communicates the converted control data to the wireless electronic device based on the wireless communication protocol.

14. The vehicle of claim 10, wherein the wherein the adapter device receives the video data and the audio data from the wireless electronic device, and converts the video data and the audio data from the data format generated by the wireless electronic device to the data format that is recognizable by the display unit of the vehicle.

15. The vehicle of claim 14, wherein the adapter device communicates the converted video data and audio data to the display unit according to the wired communication protocol.

16. The vehicle of claim 14, wherein the adapter device communicates the converted video data to the display unit according to the wired communication protocol, and communicates the converted audio data to the display unit according to the wired communication protocol.

17. The vehicle of claim 10, wherein the wired communication protocol is based on a direct communication link to the display unit.
